(19) United States
(12) Patent Application Publication
(10) Pub. No.: US 2008/0079739 A1
(43) Pub. Date: Apr. 3, 2008

(54) GRAPHICS PROCESSOR AND METHOD FOR CONTROLLING A DISPLAY PANEL IN SELF-REFRESH AND LOW-RESPONSE-TIME MODES

(76) Inventors: Abhay Gupta, San Jose, CA (US); Pierre Selwan, Fremont, CA (US); Ralph M. Mesmer, Banks, OR (US)

Correspondence Address: SCHWEGMAN, LUNDBERG & WOESSNER/Intel, PO BOX 2938, MINNEAPOLIS, MN, 55402, US

(21) Appl. No.: 11/537,165

(22) Filed: Sep. 29, 2006

(51) Int. Cl. G06F 13/14

(52) U.S. Cl. 345/520

(57) ABSTRACT

Embodiments of a graphics processor and method for controlling a display panel in self-refresh and low-response time modes are generally described herein. Other embodiments may be described and claimed. In some embodiments, a self-refresh (SR) control signal is generated for a display controller when an image represented by the frames becomes static instructing the display controller to enter SR mode. A lower-response-time (LRT) control signal is generated for the display controller when the image becomes active instructing the display controller to enter an LRT mode.

### TECHNICAL FIELD

The present invention pertains to graphics processors and methods for processing graphics data for display. Some embodiments pertain to portable computers. Some embodiments pertain to wireless communication devices.

### BACKGROUND

Graphic display systems use liquid crystal displays (LCDs) for many different applications including televisions, wireless telephones, notebook and portable computers, as well as many hand-held and portable wireless communication devices. Due to the inherent characteristics of the liquid crystal display elements, visual artifacts such as motion blur, may be present when images with high-motion content are being displayed. Displays with faster response times exhibit fewer of these visual artifacts, but are more expensive. Compensation has been conventionally applied to the elements of displays with lower response times to help reduce cost as well as reduce the occurrence of these visual artifacts. Displays with faster response times as well as displays that apply compensation generally consume more power than less-expensive displays with slower-response times. This makes it difficult to provide images with high-motion content in portable devices in a cost-effective and energy-efficient manner.

Thus, there are general needs for lower-cost display systems that provide reduced motion artifacts suitable for use in portable applications. There are also general needs for display systems suitable for displaying images with high-motion content in portable devices. There are also general needs for display systems suitable for displaying images with high-motion content that consume less power.

### BRIEF DESCRIPTION OF THE DRAWINGS

FIG. 1 illustrates a processing system and a display panel in accordance with some embodiments of the present invention;

FIG. 2 is a flow chart of a display panel control procedure in accordance with some embodiments of the present invention; and

FIG. 3 illustrates a wireless communication device in accordance with some embodiments of the present invention.

### DETAILED DESCRIPTION

The following description and the drawings sufficiently illustrate specific embodiments of the invention to enable those skilled in the art to practice them. Other embodiments may incorporate structural, logical, electrical, process, and other changes. Portions and features of some embodiments may be included in, or substituted for, those of other embodiments. Embodiments of the invention set forth in the claims encompass all available equivalents of those claims. Embodiments of the invention may be referred to herein, individually or collectively, by the term “invention” merely for convenience and without intending to limit the scope of this application to any single invention or inventive concept if more than one is in fact disclosed.

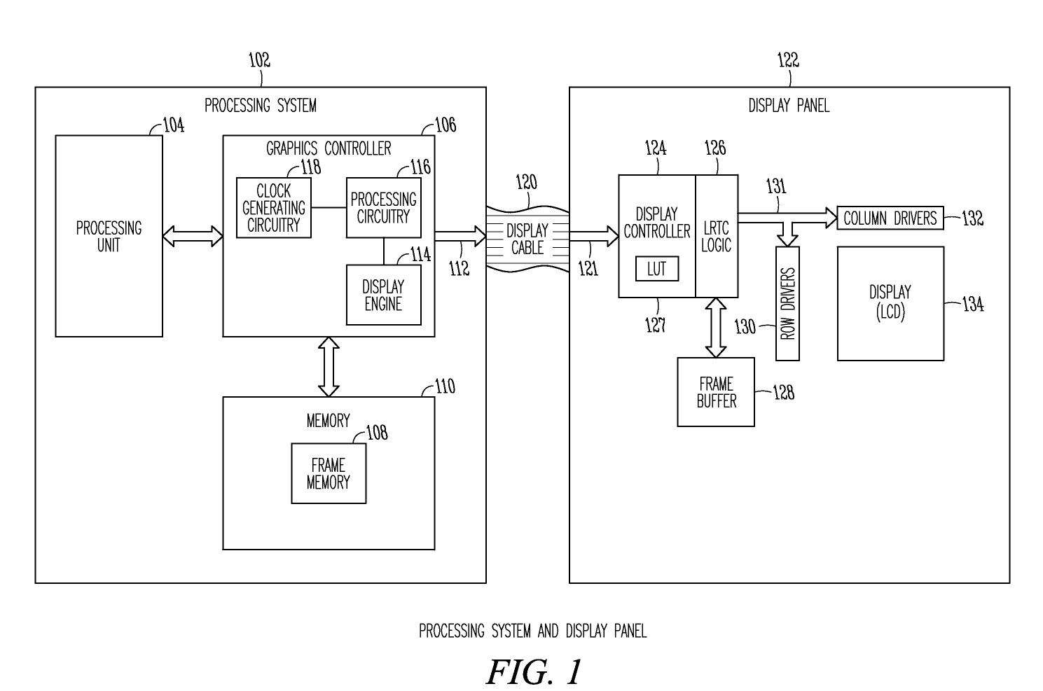

FIG. 1 illustrates a processing system and a display panel in accordance with some embodiments of the present invention. Processing system 102, among other things, generates image data for display by display panel 122. Processing system 102 includes processing unit 104, graphics controller 106 and memory 110. As illustrated, processing system 102 and display panel 122 may be coupled by display cable 120.

In some embodiments, graphics controller 106 may be a graphics chip, a graphics processing unit (GPU), or a Graphics and Memory Controller Hub (GMCH), although the scope of the invention is not limited in this respect. In some embodiments, graphics controller 106 may include processing circuitry 116 to perform various processing operations for graphics controller 106, and display engine 114 for providing frames of pixels over interface 112 for display panel 122. In some embodiments, display engine 114 may provide frames of pixels in a pixel stream manner to display panel 122. Graphics controller 106 may also include clock generating circuitry 118 to generate and/or provide clock signals and/or other timing signals for use within graphics controller 106.

In some embodiments, processing system 102 may comprise a motherboard of a personal computer, such as a portable or laptop computer. In some embodiments, processing unit 104 may comprise a microprocessor or a central processing unit (CPU) for processing system 102, although the scope of the invention is not limited in this respect.

Memory 110 may comprise random access memory (RAM), such as dynamic random access memory (DRAM), although other types of memory such as magnetic RAM (MRAM) may be suitable. Memory 110 may include frame memory 108, discussed in more detail below.

Display panel 122 may comprise display controller 124 to control the operations of display panel 122 and receive frames of pixels, as well as control signals from processing system 102. Display panel 122 may also include frame buffer 128 to store pixels of one or more prior frames, and display 134, which may be a liquid crystal display (LCD). Display 134 may have drivers, such as row drivers 130 and column drivers 132 for providing signals to drive the individual elements of display 134. Display controller 124 may include lower-response-time compensation (LRTC) logic 126 to provide compensated pixel values that may compensate for a slow response time of the elements of display 134. Display controller 124 may also include look-up-table (LUT) 127, which may be used in generating the compensated pixel values. These embodiments are discussed in more detail below. In some embodiments, display controller 124 may comprise a timing control chip or a timing controller (TCON), which may coordinate the operations on display panel 122.

Processing unit 104 may, among other things, process commands that may instruct graphics controller 106 to render a new image. Graphics controller 106 may generate the image in the form of pixel values, which may be provided to display controller 124 over interface 121. Display controller 124 may convert the image information provided by graphic controller 106 into driver signals suitable for column drivers 132, and may instruct row drivers 130 when to address a row of display 134. In some embodiments, row drivers 130 may comprise gate drivers. In some embodiments, applications, as well as other processes (e.g., mouse movement) running on processing system 102 may cause the generation of new images by processing unit 104.

In accordance with some embodiments, display engine 114 provides frames to display controller 124, and processing circuitry 116 generates a self-refresh (SR) control signal for display controller 124 when an image represented by the frames becomes static instructing display controller 124 to enter SR mode. Processing circuitry 116 may also generate a lower-response-time (LRT) control signal for display controller 124 when the image becomes active (i.e., is no longer static), instructing display controller 124 to enter LRT mode. In these embodiments, an image may be static when there is no change in screen content for a predetermined number of consecutive frames. An image may be active when there is a change in screen content between two consecutive frames, although the scope of the invention is not limited in this respect.

During LRT mode, display engine 114 may provide frames of current pixel values to display controller 124 of display panel 122 over interface 112. During SR mode, pixel values of a prior frame stored in frame buffer 128 on display panel 122 are used for displaying on display 134. During LRT mode, the current pixel values provided by display engine 114 over interface 112 are used by display controller 124 for displaying on display 134. These embodiments are discussed in more detail below. In some embodiments, frame buffer 128 may comprise RAM, such as DRAM, although other memory types may be suitable.

In some embodiments, graphics controller 106 uses frame memory 108 to store the pixel values for one or more prior frames. Processing circuitry 116 determines when the image becomes static by comparing pixel values of a current frame with pixel values of the one or more prior frames. In some embodiments, the image becomes static when substantially all pixel values of the current frame have not changed for either a predetermined number of frames or predetermined time period (e.g., 10-20 milliseconds (ms)), although the scope of the invention is not limited in this respect.

In some embodiments, after instructing display controller 124 to enter SR mode, processing circuitry 116 may determine that the image becomes active when any one or more pixel values of the current frame change with respect to a prior frame. In some embodiments, processing circuitry 116 causes display controller 124 to remain in LRT mode during video playback, although the scope of the invention is not limited in this respect.

In some embodiments, graphics controller 106 provides the SR control signal and the LRT control signal as in-band signals over interface 112 to display controller 124. In these embodiments, the in-band signals may be provided during a vertical blanking interval (VBI), although the scope of the invention is not limited in this respect. In these embodiments, interface 112 between display engine 114 and display controller 124 may be placed in command mode for communicating command signals, and may be placed in data mode for communicating data, such as frames of pixels, although the scope of the invention is not limited in this respect.

In some other embodiments, graphics controller 106 provides the SR control signal and the LRT control signal as out-of-band signals over interface 112 to display controller 124. In these embodiments, the control signals may be sent as side-band signals using side-band signaling over interface 112, although the scope of the invention is not limited in this respect. In some embodiments, interface 112 may operate in accordance with a Mobile Industry Processor Interface (MIPI) using side-band signals in which the data signals and control signals are separate, although the scope of the invention is not limited in this respect.

In some embodiments, processing circuitry 116 causes display engine 114 to refrain from providing current frames of image data after the SR control signal is generated for display controller 124. In these embodiments, after the SR control signal is generated, processing circuitry 116 causes graphics controller 106 to shut down internal clock generating circuitry 118 to reduce power consumption. When in SR mode, display controller 124 may remain in SR mode until it receives the LRT control signal from the processing circuitry 116. When in LRT mode, display controller 124 may remain in LRT mode until it receives the SR control signal from the processing circuitry 116. When processing circuitry 116 generates the LRT control signal, clock generating circuitry 118 that was shut down in SR mode may be restarted to generate the internal clock signals allowing current pixel values to be sent over interface 112.

In some embodiments, when display 134 is an LCD, during LRT mode, display controller 124 may apply LRT compensation to pixel values of a current frame, based on corresponding pixel values of a prior frame and the current frame using LUT 127 prior to the pixels being displayed by display 134. Display controller 124 may apply LRT compensation to reduce motion blur resulting from the slower response time of elements of display 134. In some embodiments, when there is higher motion, the LRT compensation may increase one or more pixel values of the current frame when the one or more pixel values of the current frame are greater than corresponding pixel values of the prior frame. The increased pixel values may overdrive the elements of display 134 during the current frame to compensate for the luminance response delay of the elements. In this way, the desired pixel value can be reached during the current frame. In some cases when there is higher motion, the LRT compensation may decrease one or more pixel values of the current frame when the one or more pixel values of the current frame are less than corresponding pixel values of the prior frame. The decreased pixel values may under-drive the elements of display 134. In some other cases where there is less motion, the LRT compensation may neither increase nor decrease one or more pixel values of the current frame when the one or more pixel values of the current frame have substantially the same values as corresponding pixel values of the prior frame.

In these embodiments, the compensation values stored in LUT 127 may be based on the response time of the elements of display 134. In some embodiments, LUT 127 may be initialized with a read-only memory, such as an electronically-erasable programmable read only memory (EEPROM), external to display controller 124, although the scope of the invention is not limited in this respect.

During SR mode, LRT logic circuitry 126 may refrain from providing compensated pixel values, allowing pixel values of a prior frame from frame buffer 128 to be provided to the drivers of display 134. In some embodiments, during LRT mode, display controller 124 further applies gamma correction to pixel values of the current frame prior to the LRT compensation, although the scope of the invention is not limited in this respect, as gamma correction may be applied after LRT compensation.

In some embodiments, processing system 102 and display panel 122 may be part of a portable computer. In some other embodiments, processing system 102 and display panel 122 may be part of a portable wireless communication device that includes a transceiver coupled to the processing system for communicating wireless communication signals. These embodiments are discussed in more detail below.

Although processing system 102 and display panel 122 are illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of processing system 102 and display panel 122 may refer to one or more processes operating on one or more processing elements.

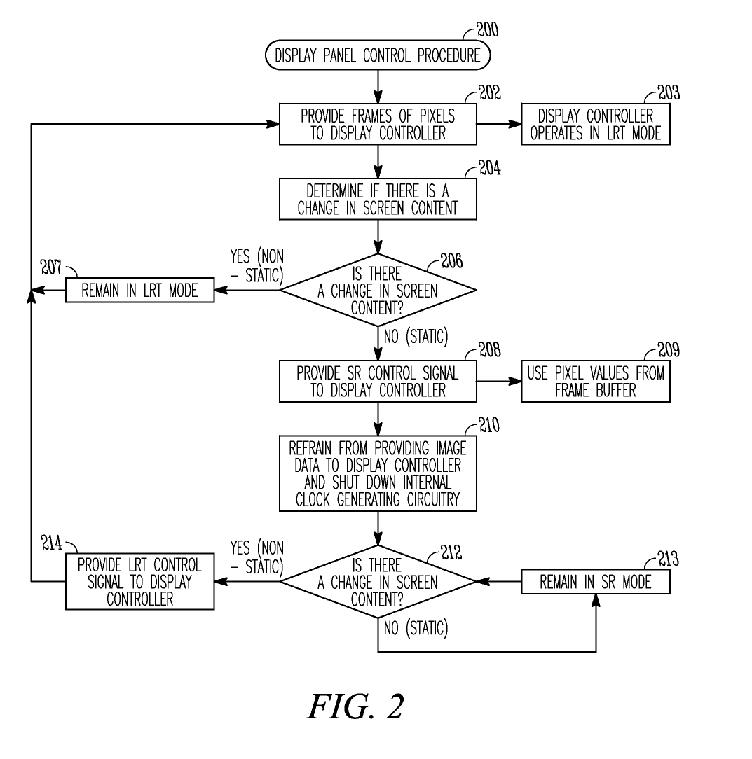

FIG. 2 is a flow chart of a display panel control procedure in accordance with some mode-switching embodiments of the present invention. Display panel control procedure 200 may be performed by a graphics controller, such as graphics controller 106 (FIG. 1), although other graphics controllers and graphics processors may also be used to perform procedure 200. Display panel control procedure 200 may allow a display panel to switch between LRT mode and SR mode depending on the screen content to be displayed.

In operation 202, frames of pixels are provided to a display controller, such as display controller 124 (FIG. 1). During operation 203, the display controller may operate in LRT mode, displaying the frames of pixels that are currently provided by the graphics controller.

In operation 204, the graphics controller may determine if there is a change in screen content. In some embodiments, the graphics controller may compare pixels of a current frame with pixels of one or more prior frames.

In operation 206, when there is a change in screen content, the image may be considered non-static and operation 207 may be performed. When there is no change in screen content, the image may be considered static and operation 208 may be performed.

In operation 207, the display controller may remain in LRT mode and operations 202 through 206 may be repeated until the image becomes static. In operation 208, the graphics controller provides an SR control signal to the display controller. The SR control signal may instruct the display controller to enter the SR mode.

In operation 209, during SR mode the display controller uses pixel values from the frame buffer for display. In operation 210, the graphics controller may refrain from providing image data to the display controller and may shut down internal clock generating circuitry as well as other internal circuitry.

In operation 212, the graphics controller may determine when there is a change in screen content by comparing pixels of the prior frame with pixels of the current frame. In some embodiments, processing unit 104 (FIG. 1) and/or graphics controller 106 (FIG. 1) may generate new frames or images. The new frames or images may result from one or more applications running on processing system 102 (FIG. 1) or may result from user actions such as mouse movement, although the scope of the invention is not limited in this respect. When it is determined that the image is still be static, the display controller may remain in SR mode in accordance with operation 213. When it is determined that the image is non-static, operation 214 may be performed.

In operation 214, the graphics controller may provide an LRT control signal to the display controller instructing the display controller to enter the LRT mode. As part of operation 214, the internal clock generating circuitry as well as any other circuitry that was shut down in SR mode may be restarted. During LRT mode, operations 202 through 206 may be repeated until there is no change in screen content as discussed above.

Although the individual operations of procedure 200 are illustrated and described as separate operations, one or more of the individual operations may be performed concurrently, and nothing requires that the operations be performed in the order illustrated.

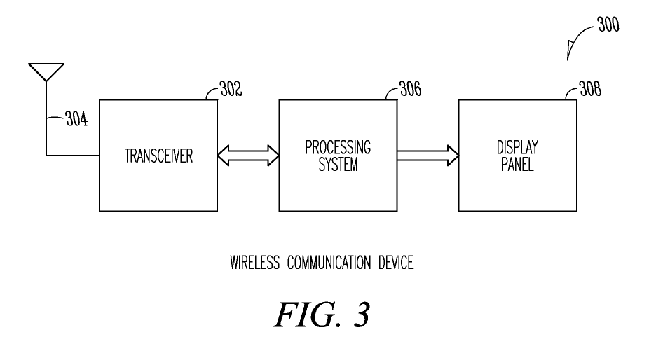

FIG. 3 illustrates a wireless communication device in accordance with some embodiments of the present invention. Wireless communication device 300 includes transceiver 302 for communicating radio-frequency (RF) signals with other wireless communication devices using antenna 304. Wireless communication device 300 also includes processing system 306 for providing signals to transceiver 302 for transmission, and for processing signals received by transceiver 302. Wireless communication device 300 also includes display panel 308 for displaying images with high motion content in accordance with image data and control signals from processing system 306. In some embodiments, the image data may be received through antenna 304. In other embodiments, wireless communication device 300 may include a digital camera and the image data with high motion content may be generated by digital image capturing circuitry within wireless communication device 300. In these embodiments, the image data may be displayed by display panel 308 and transmitted using transceiver 302, although the scope of the invention is not limited in this respect. In some embodiments, processing system 306 may correspond to processing system 102 (FIG. 1) and display panel 308 may correspond to display panel 122 (FIG. 1).

Wireless communication device 300 may be almost any portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, transceiver 302 may communicate using orthogonal frequency division multiplexed (OFDM) communication signals over a multicarrier communication channel. In some embodiments, transceiver 302 may communicate using orthogonal frequency division multiple access (OFDMA) communication signals. In some embodiments, transceiver 302 may communicate using spread-spectrum signals, although the scope of the invention is not limited in this respect.

In some embodiments, wireless communication device 300 may be part of a communication station, such as wireless local area network (WLAN) communication station including a Wireless Fidelity (WiFi) communication station, an access point (AP) or a mobile station (MS). In some other embodiments, wireless communication device 300 may be part of a broadband wireless access (BWA) network communication station, such as a Worldwide Interoperability for Microwave Access (WiMax) communication station, although the scope of the invention is not limited in this respect as wireless communication device 300 may be part of almost any wireless communication device.

In some embodiments, the frequency spectrums for the communication signals transmitted and received by wireless communication device 300 may comprise frequencies between 2 and 11 GHz, although the scope of the invention is not limited in this respect.

Antenna 304 may comprise one or more directional or omnidirectional antennas, including, for example, dipole antennas, monopole antennas, patch antennas, loop antennas, microstrip antennas or other types of antennas suitable for transmission of RF signals. In some multiple-input, multiple-output (MIMO) embodiments, two or more antennas may be used.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Some embodiments of the invention may be implemented in one or a combination of hardware, firmware and software. Some embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus, the following claims are hereby incorporated into the detailed description, with each claim standing on its own as a separate preferred embodiment.

What is claimed is:

1. A graphics controller comprising:
a display engine to provide frames to a display controller; and
processing circuitry to generate a self-refresh (SR) control signal for the display controller when an image represented by the frames becomes static instructing the display controller to enter SR mode,
wherein the processing circuitry further generates a lower-response-time (LRT) control signal for the display controller when the image becomes active instructing the display controller to enter an LRT mode.

2. The graphics controller of claim 1 wherein during the LRT mode, the display engine provides frames of current pixel values to the display controller of a display panel over an interface,
wherein during the SR mode, pixel values of a prior frame stored in a frame buffer on the display panel are used for displaying on a display, and
wherein during the LRT mode, the current pixel values provided by the display engine over the interface are used by the display controller for displaying on the display.

3. The graphics controller of claim 2 wherein the graphics controller is coupled to a frame memory to store the pixel values for one or more prior frames,
wherein the processing circuitry determines when the image becomes static by comparing pixel values of a current frame with pixel values of the one or more prior frames, and
wherein the image becomes static when substantially all pixel values of the current frame have not changed for either a predetermined number of frames or a predetermined time period.

4. The graphics controller of claim 3 wherein, after instructing the display controller to enter the SR mode, the processing circuitry determines that the image becomes active when any one or more pixel values of the current frame change with respect to a prior frame.

5. The graphics controller of claim 2 wherein the graphics controller provides the SR control signal and the LRT control signal as in-band signals over the interface to the display panel.

6. The graphics controller of claim 2 wherein the graphics controller provides the SR control signal and the LRT control signal as out-of-band signals over the interface to the display panel.

7. The graphics controller of claim 2 wherein the processing circuitry causes the display engine to refrain from providing current frames after the SR control signal is generated for the display controller,
wherein after the SR control signal is generated, the processing circuitry causes the graphics controller to shut down internal clock generating circuitry to reduce power consumption,
wherein when in the SR mode, the display controller remains in the SR mode until it receives the LRT control signal from the graphics processor, and
wherein when in the LRT mode, the display controller remains in the LRT mode until it receives the SR control signal from the graphics processor.

8. The graphics controller of claim 2 wherein the display is a liquid crystal display,
wherein during the LRT mode, the display controller applies LRT compensation to pixel values of a current frame based on corresponding pixel values of a prior frame and the current frame using a look-up table (LUT) prior to the pixel values being displayed by the display,
wherein the LUT is stored within the display controller, and
wherein the display controller applies the LRT compensation to reduce motion blur resulting from a response time of elements of the display.

9. The graphics controller of claim 1 wherein the display controller is part of a display panel coupled to a processing system with a display cable,
wherein the graphics controller is part of the processing system, and
wherein the display panel further comprises a liquid crystal display.

10. The graphics controller of claim 10 wherein the processing system and display panel are part of a portable wireless communication device and includes a transceiver coupled to the processing system for communicating wireless communication signals.

11. A method for operating a graphics controller comprising:
generating a self-refresh (SR) control signal for a display controller when an image represented by current frames becomes static, the SR control signal instructing the display controller to enter SR mode; and
generating a lower-response-time (LRT) control signal for the display controller when the image becomes active instructing the display controller to enter an LRT mode.

12. The method of claim 11 wherein during the LRT mode, the method comprises providing the current frames of current pixel values to the display controller of a display panel over an interface,
wherein during the SR mode, pixel values of a prior frame stored in a frame buffer on the display panel are used for displaying on a display, and
wherein during the LRT mode, the current pixel values provided over the interface are used by the display controller for displaying on the display.

13. The method of claim 12 further comprising:
storing the pixel values for one or more prior frames; and
determining when the image becomes static by comparing pixel values of the current frame with the stored pixel values of the one or more prior frames,
wherein the image is static when pixel values of the current frame have not changed for either a predetermined number of frames or a predetermined time period.

14. The method of claim 13 wherein, after instructing the display controller to enter the SR mode, the method further comprises determining that the image becomes active when any one or more pixel values of the current frame change with respect to a prior frame.

15. The method of claim 12 further comprising providing the SR control signal and the LRT control signal as in-band signals over the interface to the display panel.

16. The method of claim 12 further comprising providing the SR control signal and the LRT control signal as out-of-band signals over the interface to the display panel.

17. The method of claim 11 further comprising refraining from providing current frames after the SR control signal is generated,
wherein after the SR control signal is generated, the method further comprises:
instructing a graphics controller to shut down internal clock generating circuitry to reduce power consumption;
remaining, by the display controller, in the SR mode until the LRT control signal is received from a graphics processor; and
remaining, by the display controller, in the LRT mode until the SR control signal is received from the graphics processor.

18. The method of claim 12 wherein the display is a liquid crystal display,
wherein during the LRT mode, the display controller applies LRT compensation to pixel values of a current frame based on corresponding pixel values of a prior frame and the current frame using a look-up table (LUT) prior to the being displayed by the display,
wherein the LUT is stored within the display controller, and
wherein the display controller applies the LRT compensation to reduce motion blur resulting from a response time of elements of the display.

19. A portable computer system comprising:
a graphics controller;
a processing unit coupled to the graphics controller; and
a display panel with a frame buffer coupled to the graphics controller,
wherein the graphics controller comprises:
a display engine to provide frames to a display controller on the display panel; and
processing circuitry to generate a self-refresh (SR) control signal for the display controller when an image represented by the frames becomes static instructing the display controller to enter SR mode,
wherein the processing circuitry further generates a lower-response-time (LRT) control signal for the display controller when the image becomes active instructing the display controller to enter an LRT mode.

20. The portable computer system of claim 19 wherein during the LRT mode, the display engine provides frames of current pixel values to the display controller over an interface,
wherein during the SR mode, pixel values of a prior frame stored in a frame buffer on the display panel are used for displaying on a display, and
wherein during the LRT mode, the current pixel values provided by the display engine over the interface are used by the display controller for displaying on the display.

21. The portable computer system of claim 20 wherein the graphics controller is coupled to a frame memory to store the pixel values for one or more prior frames,
wherein the processing circuitry determines when the image becomes static by comparing pixel values of a current frame with the stored pixel values of the one or more prior frames, and
wherein the image becomes static when substantially all pixel values of the current frame have not changed for either a predetermined number of frames or a predetermined time period.
